(19) United States
(12) Patent Application Publication
(10) Pub. No.: US 2009/0063149 A1
(43) Pub. Date: Mar. 5, 2009

(54) Speech retrieval apparatus

(75) Inventor: Takeshi Iwaki, Tokyo (JP)

Correspondence Address: RABIN & Berdo, PC, 1101 14TH STREET, NW, SUITE 500, WASHINGTON, DC, 20005, US

(73) Assignee: Oki Electric Industry Co., Ltd., Tokyo (JP)

(21) Appl. No.: 12/219,048

(22) Filed: Jul. 15, 2008

(30) Foreign Application Priority Data
Aug. 30, 2007 (JP) 2007-223380

(51) Int. Cl. G10L 15/04

(52) U.S. Cl. 704/251; 704/E15.001

(57) ABSTRACT

A speech retrieval apparatus derives a times series of pitch or power values of speech input as a retrieval condition, obtains a pattern of local maxima, local minima, and inflection points in the time series, compares this pattern with similar patterns obtained from speech stored in a speech database, and outputs only stored speech for which the compared patterns approximately match. Correct retrieval results are thereby obtained even from speech input including multiple accent nuclei.

### BACKGROUND OF THE INVENTION

1. Field of the Invention

The present invention relates to a speech retrieval apparatus that uses input speech as a retrieval condition to retrieve speech from a speech database.

2. Description of the Related Art

Japanese Patent Application Publication No. 2004-240201 discloses a speech synthesizer that employs prosodic data created from actual speech sounds to synthesize high-quality speech from Japanese text. The text is converted to phonetic symbols and analyzed into accent phrases, which are used to retrieve prosodic patterns derived from samples of natural speech from a database. The retrieved prosodic patterns are then used to generate synthesized speech that sounds approximately like natural speech.

This technique is useful for synthesizing speech, but there is also a need to retrieve speech, or information tagged by speech, by using input speech instead of text as a retrieval condition. Such a capability could, for example, enable a person to speak a phrase and obtain images or information related to the spoken phrase.

Although the above disclosure does not provide such a speech retrieval capability, it offers techniques that could be used implement this capability. However, there are problems in using the disclosed techniques for that purpose.

In particular, the accent phrases employed in the above disclosure are phrases including a single pitch accent each. The disclosed technique would therefore deal with expressions including a large number of accent nuclei, such as emotional expressions and the set expressions referred to as catch phrases, by dividing them into smaller units and using the smaller units as retrieval conditions. This strategy could easily lead to the retrieval of speech unrelated to the input expression or phrase.

### SUMMARY OF THE INVENTION

An object of the invention is to provide a speech retrieval apparatus that can use spoken phrases or expressions as retrieval conditions even if when the phrases or expressions include multiple accent nuclei.

The invented speech retrieval apparatus retrieves speech from a speech database by using speech input received by a speech input unit as a retrieval condition. A speech analysis unit calculates values of one or more properties of the speech input. A pattern extraction unit derives a temporal pattern of the calculated values, determines differences between the derived temporal pattern and temporal patterns of the speech stored in the speech database, and outputs speech for which the difference is less than a predetermined threshold value.

The properties may include pitch and power, and the speech database may store temporal pitch and power patterns together with speech data.

The pattern extraction unit may obtain the temporal patterns by finding local maxima, local minima, and inflection points in the time series.

When necessary, the pattern extraction unit may rederive the pitch time series pattern of a stored speech item so that the number of local maxima, local minima, and inflection points of the stored speech item does not exceed the number of local maxima, local minima, and inflection points of the speech input as a retrieval condition.

### BRIEF DESCRIPTION OF THE DRAWINGS

In the attached drawings:

FIG. 1 is a functional block diagram of a speech retrieval apparatus embodying the invention;

FIG. 2 is a flowchart illustrating the analysis of a speech signal by the speech analysis unit in FIG. 1;

FIG. 3 is a flowchart illustrating the derivation and analysis of a pitch time series by the pattern extraction unit in FIG. 1;

FIG. 4 is a graph illustrating a pitch time series;

FIG. 5 is a flowchart illustrating the derivation and analysis of a power time series by the pattern extraction unit in FIG. 1;

FIG. 6 is a flowchart illustrating the speech retrieval process performed by the pattern extraction unit;

FIG. 7 is a flowchart illustrating the feature difference calculation processes in FIG. 6; and

FIG. 8 is a flowchart illustrating the rederivation of a pitch time series.

### DETAILED DESCRIPTION OF THE INVENTION

Embodiments of the invention will now be described with reference to the attached drawings, in which like elements are indicated by like reference characters.

### First Embodiment

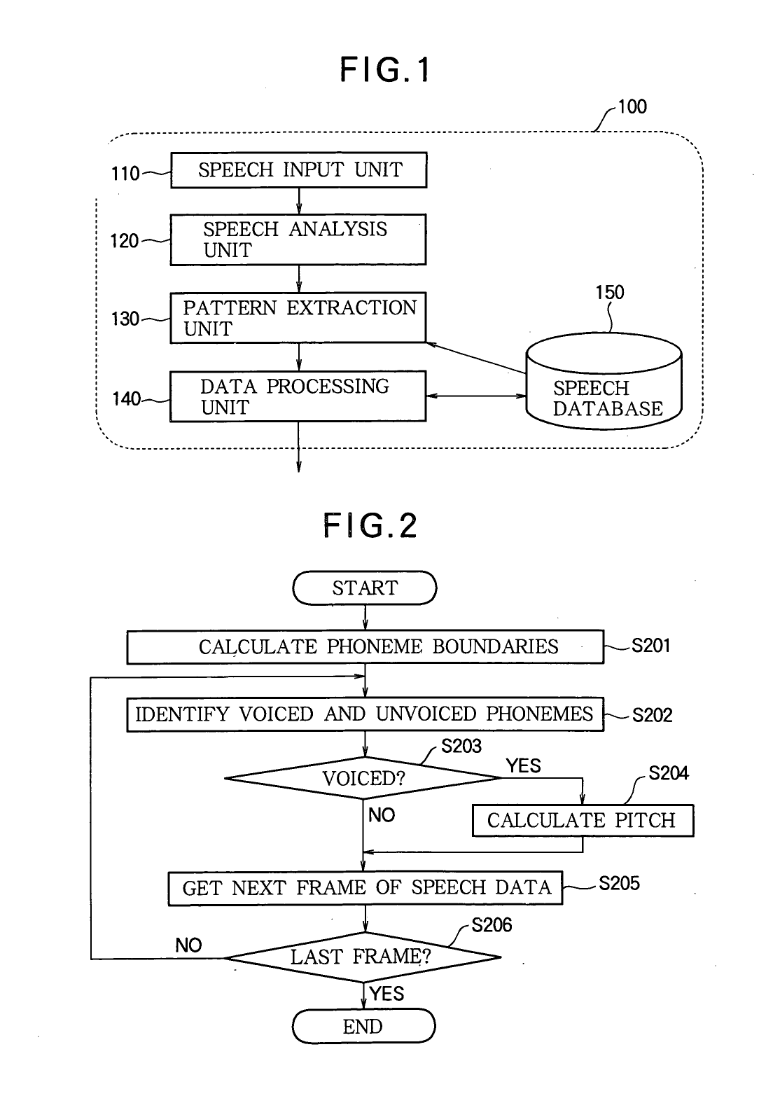

The speech retrieval apparatus 100 in the first embodiment is configured from a speech input unit 110, a speech analysis unit 120, a pattern extraction unit 130, a data processing unit 140, and a speech database 150 as shown in FIG. 1.

The speech input unit 110 has one or more interfaces for receiving speech input as a retrieval condition and speech to be stored in the speech database 150. The interfaces may include a microphone that receives raw voice input from the user, and/or means for receiving speech that has already been converted to speech data or a speech signal. The speech input to the speech input unit 110 is output as a speech signal to the speech analysis unit 120.

The speech analysis unit 120 analyzes the speech signal received from the speech input unit 110 to identify phonemes, decide whether they are voiced or unvoiced, and determine the pitch (fundamental frequency F₀) of voiced phonemes. The analysis process will be described in more detail later.

The pattern extraction unit 130 extracts a prosodic pattern expressing features of the input speech from the results of the analysis performed by the speech analysis unit 120. The pattern extraction process will be described in more detail later.

The data processing unit 140 outputs speech obtained from the speech database 150 as a retrieval result, and stores new speech in the speech database 150.

The speech database 150 stores a plurality of speech items such as, for example, wave sound files (‘wav’ files), and accepts new speech items from the data processing unit 140. Together with the speech data, the speech database 150 also stores pitch time series data and power time series data, and pitch patterns and power patterns derived therefrom. The speech database 150 may be external to the speech retrieval apparatus 100.

The speech analysis unit 120, pattern extraction unit 130, and data processing unit 140 may be implemented in hardware circuits that carry out the above functions, or in software running on a computing device such as the central processing unit (CPU) of a microcomputer or microprocessor. The speech database 150 may comprise a memory device such as a hard disk drive (HDD), or designated areas therein.

The speech retrieval apparatus 100 carries out two types of operations: storing new speech in the speech database 150 and retrieving speech from the speech database 150. Each operation will now be described in more detail.

First the analysis of speech input by the speech analysis unit 120 will be described with reference to the flowchart in FIG. 2. The process in FIG. 2 is used both to analyze speech input received by the speech input unit 110 as a retrieval condition and to analyze speech to be stored in the speech database 150.

In step S201, the speech analysis unit 120 obtains speech data captured by the speech input unit 110 in a series of short frames and determines the phoneme to which each frame belongs. This step includes calculation of the power of each frame and determination of phoneme boundaries. This step may be carried out by the use of hidden Markov models, a known technique that is also exploited to identify phonemes during the construction of a corpus for use in corpus-based speech synthesis.

In step S202, the speech analysis unit 120 decides whether the current frame represents a voiced sound or an unvoiced sound. This step may be carried out by conventional techniques, such as deciding whether the speech power level of the current frame exceeds a certain threshold value, or deciding whether there is a pitch component in the autocorrelation of a residual signal.

If the decision in step S203 is that the current frame represents a voiced sound, the process proceeds to step S204. If the decision is that the current frame represents an unvoiced sound, the process proceeds to step S205.

In step S204, the speech analysis unit 120 calculates the pitch period of the current frame. The pitch period is the reciprocal of the fundamental frequency.

In step S205, the speech analysis unit 120 proceeds to the next frame of speech data.

In step S206, if there is a next frame, that is, if the frame just analyzed is not the last frame, the speech analysis unit 120 returns to step S202 and repeats the operation from steps S202 to S205. If the current frame is the last frame, the process ends.

Next, the processes performed by the pattern extraction unit 130 will be described. The pattern extraction unit 130 performs different processes for storing and retrieving speech. First, the processes for storing speech will be described.

When speech is stored in the speech database 150, the pattern extraction unit 130 performs a pitch pattern extraction process and a power pattern extraction process.

Pitch pattern extraction yields the pitch features of the prosodic pattern (expressing pitch, power, and duration) of the speech. Power pattern extraction yields the power features. Information on duration may also be extracted by extracting the pitch and power features in time series form. The extracted information characterizes the input speech item and is stored together with the speech data in the speech database 150 for later use in retrieving the speech item.

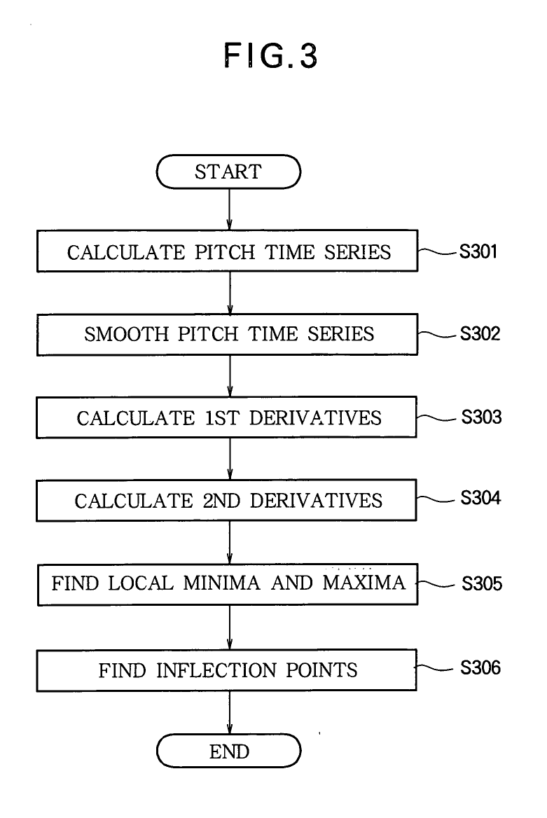

The pitch pattern extraction process is illustrated in FIG. 3.

In step S301, the pattern extraction unit 130 calculates a pitch time series of the speech signal received from the speech input unit 110. This pitch time series represents the time-varying fundamental frequency (F₀) of the speech signal. The pitch periods calculated in step S204 in FIG. 2 may be used as the values of this pitch time series. For enhanced precision and reduced pitch error, the average values of pitch periods obtained by a plurality of different methods, such as the residual autocorrelation method and cepstrum method, may be used. The result of step S301 is a pitch time series waveform.

In step S302, the pattern extraction unit 130 smoothes the pitch time series waveform obtained in step S301. Various smoothing methods may be used, such as calculating short-term moving averages or using a low-pass filter.

In step S303, the pattern extraction unit 130 differentiates the smoothed pitch time series waveform obtained in step S302 to calculate a velocity waveform of the pitch time series.

In step S304, the pattern extraction unit 130 differentiates the velocity waveform obtained in step S303 to calculate an acceleration waveform of the pitch time series.

In step S305, the pattern extraction unit 130 finds the times when the velocity of the pitch time series is zero and the acceleration is non-zero, thereby finding the local minima and local maxima in the pitch time series.

In step S306, the pattern extraction unit 130 finds the times when the acceleration of the pitch time series is zero, thereby finding the inflection points of the pitch time series.

The extracted local minima and maxima and inflection points represent the pitch pattern of the input speech.

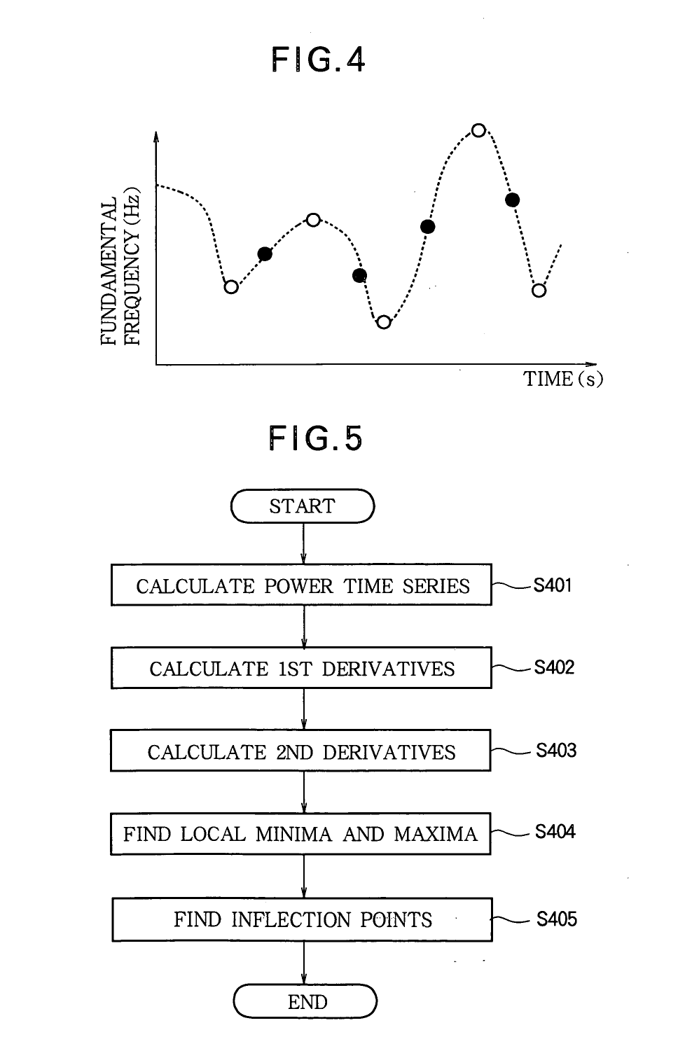

A typical pitch pattern extracted by the pattern extraction unit 130 is illustrated in FIG. 4. Time coordinates are indicated on the horizontal axis and fundamental frequency value (or pitch period) coordinates are indicated on the vertical axis. Local minima and local maxima, indicated by white circles, occur alternately, separated by inflection points, indicated by black circles. Extracting these features from a waveform is an effective way to characterize the waveform pattern. The time and value coordinates of the extracted local minima and maxima and inflection points are stored as pitch pattern data in association with the input speech data in the speech database 150.

The power pattern extraction process, illustrated by the flowchart in FIG. 5, is generally similar to the pitch pattern extraction process.

In step S401, the pattern extraction unit 130 obtains a power time series comprising the speech power in each frame of the input speech signal. Because of the structure of the human vocal tract, the power time series can be assumed to have a smooth signal waveform, so no smoothing process is necessary.

In step S402, the pattern extraction unit 130 differentiates the power time series waveform obtained in step S401 to calculate a velocity waveform of the power time series.

In step S403, the pattern extraction unit 130 differentiates the velocity waveform obtained in step S402 to calculate an acceleration waveform of the power time series.

In step S404, the pattern extraction unit 130 finds the times when the velocity of the power time series is zero and the acceleration is non-zero, thereby finding local minima and maxima of the power time series.

In step S405, the pattern extraction unit 130 finds the times when the acceleration of the power time series is zero, thereby finding the inflection points of the power time series.

The times and power values of the local minima and maxima and inflection points found in steps S401 to S405 are stored as power pattern data in association with the input speech data in the speech database 150.

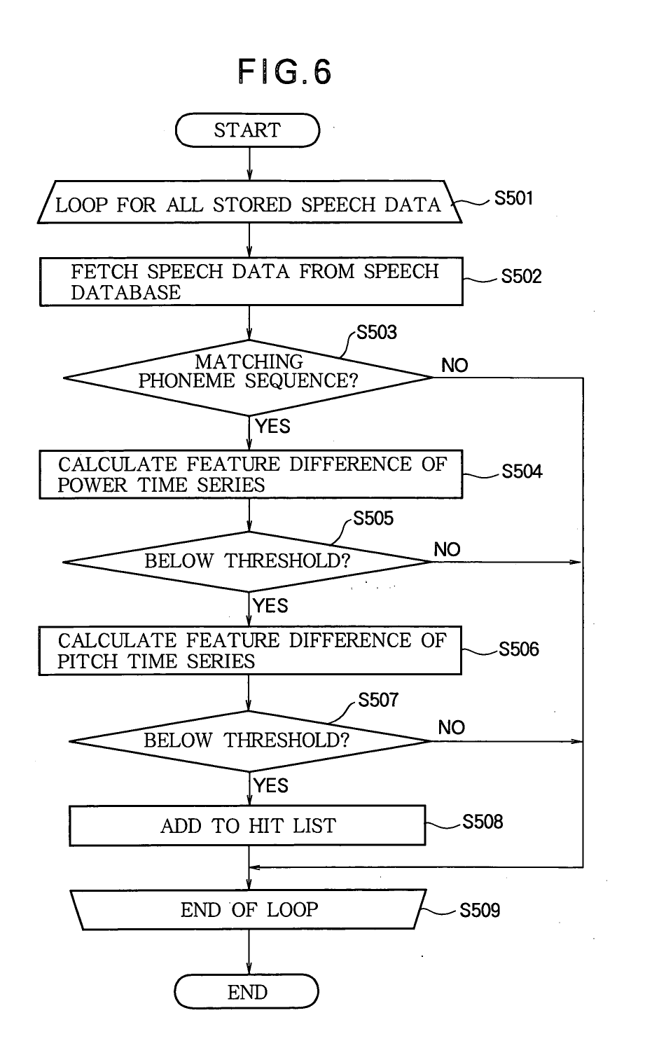

Next, the speech retrieval process performed by the pattern extraction unit 130 will be described with reference to the flowchart in FIG. 6.

Before the steps shown in FIG. 6, speech has been input to the speech input unit 110 as a retrieval condition, the speech input has been analyzed by the speech analysis unit 120 by the process illustrated in FIG. 2, and the pattern extraction unit 130 has carried out the pitch pattern and power pattern extraction processes illustrated in FIGS. 3 and 5.

Steps S501 and S509 are loop control steps causing the pattern extraction unit 130 to perform steps S502 to S508 for all speech data stored in the speech database 150.

In step S502, the pattern extraction unit 130 fetches an item of speech data from the speech database 150.

In step S503, the pattern extraction unit 130 decides whether the phoneme sequence of the input speech signal calculated by the speech analysis unit 120 in step S201 matches the phoneme sequence of the speech item obtained from the speech database 150 in step S502. The match need not be perfect. For example, the pattern extraction unit 130 may exclude pause intervals in deciding whether the two phoneme sequences match.

If the decision is that the phoneme sequences match, the process proceeds to step S504. If the decision is that the phoneme sequences do not match, the pattern extraction unit 130 proceeds to the next item of speech data as directed by the loop control steps S501 and S509.

In step S504, the pattern extraction unit 130 compares the power pattern of the input speech signal extracted in steps S401 to S405 with the power pattern of the speech item obtained from the speech database 150 in step S502 and calculates a feature difference indicating the similarity of the power features of the two speech waveforms.

The feature difference calculated in step S504 is compared with a predetermined threshold in step S505. If the feature difference is equal to or less than the predetermined threshold, the pattern extraction unit 130 proceeds to step S506. If the feature difference exceeds the predetermined threshold, the pattern extraction unit 130 proceeds to the next item of speech data as directed by the loop control steps S501 and S509.

In step S506, the pattern extraction unit 130 compares the pitch pattern waveform of the input speech signal extracted in steps S301 to S306 with the pitch pattern waveform of the speech item obtained from the speech database 150 in step S502 and calculates another feature difference, indicating the similarity of the pitch features of the two speech waveforms.

The feature difference calculated in step S506 is compared with another predetermined threshold in step S507. If the feature difference is equal to or less than the predetermined threshold, the pattern extraction unit 130 proceeds to step S508. If the feature difference exceeds the predetermined threshold, the pattern extraction unit 130 proceeds to the next item of speech data as directed by the loop control steps S501 and S509.

The feature difference calculation processes in steps S504 and S506 will be described in more detail later.

In step S508, the pattern extraction unit 130 adds information indicating that the speech item obtained from the speech database 150 in step S502 matches the retrieval condition to an internal hit list.

When the process from steps S501 to S508 has been carried out for all speech items in the speech database 150, the hit list indicates all the items of speech stored in the speech database 150 that match the speech input by the speech input unit 110 as a retrieval condition. The indicated items are the retrieval results.

If the hit list indicates at least one matching speech item, the data processing unit 140 outputs the associated speech data. If the hit list is empty, the data processing unit 140 outputs a message stating that no matching speech items were found. Various speech output methods may be used, such as audible reproduction of the speech data, or output of the speech data as data through a suitable interface.

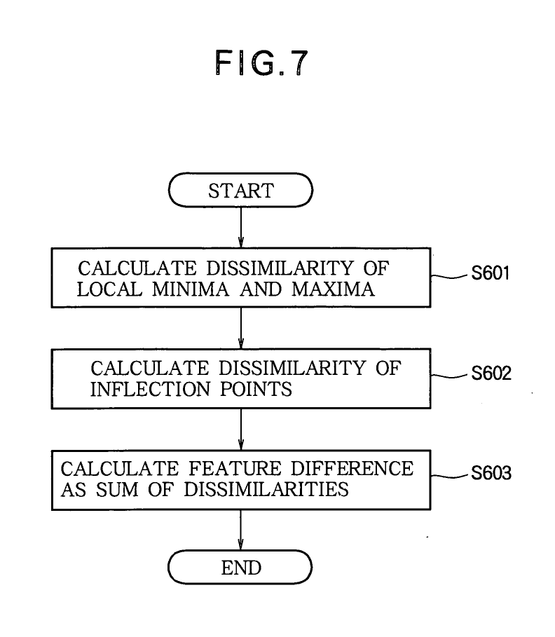

The feature difference calculation processes in steps S504 and S506 in FIG. 6 is illustrated in FIG. 7. The same process is used to calculate both pitch and power feature differences.

In step S601, the pattern extraction unit 130 compares the times of local maxima and local minima in the pitch or power pattern of the speech input as a retrieval condition with the times of local maxima and local minima in the pitch or power pattern fetched from the speech database 150 in step S502, and calculates their dissimilarity.

The dissimilarity of a local minimum or maximum in the pattern derived from the speech input and a local minimum or maximum in the pattern fetched from the speech database 150 is calculated by adding the square of the difference in the times of occurrence of the two local minima or maxima to the square of the difference between the values of the two local minima or maxima. This calculation is performed over all local minima and maxima and the results are summed to obtain the minima-maxima dissimilarity of the two time series.

In step S602, the pattern extraction unit 130 compares the times of inflection points in the pitch or power pattern derived from the speech input as a retrieval condition with the times of inflection points in the pitch or power pattern fetched from the speech database 150 in step S502 and calculates their dissimilarity.

In step S602, as in step S601, the dissimilarity of an inflection point in the pattern derived from the speech input and an inflection point in the pattern fetched from the speech database 150 is calculated by adding the square of the difference in the times of occurrence of the two inflection points to the square of the difference between their values. This calculation is performed over all inflection points and the results are summed to obtain the inflection dissimilarity of the two time series.

In step S603, the pattern extraction unit 130 adds the minima-maxima dissimilarity calculated in step S601 to the inflection dissimilarity calculated in step S602 to obtain the feature difference.

The first embodiment uses prosodic patterns to distinguish between speech items that have the same phoneme sequence, such as ‘great coathanger’ and ‘greatcoat hanger’. Since prosodic patterns are compared on the basis of the local minima and maxima and inflection features of pitch and power waveforms, it is not necessary for the absolute values of the waveforms to match; it suffices for the waveforms to have the same general shapes. The second embodiment, described below, further extends this general similarity technique.

In finding matching speech data, the first embodiment does not use spectral matching because a spectrum expresses voice features of the individual speaker. When speech is input as a retrieval condition, the main purpose is presumably to find speech with matching content in terms of what is said. If excessive voice features are added to the retrieval criteria, an individual will only be able to retrieve speech spoken by the individual himself or herself.

The pitch pattern and power pattern criteria used in the first embodiment provide retrieval results that are generally speaker-independent.

In summary, the first embodiment obtains a pitch time series and a power time series from speech input received by the speech input unit 110, locates local minima and maxima by finding times when the first derivatives of these time series are zero, locates inflection points by finding times when the second derivatives are zero, compares these features with corresponding features of speech stored in the speech database 150 and calculates feature differences. As a result, the first embodiment can retrieve a speech item on the basis of the general shape of its pitch and power waveforms, instead of the specific shapes of individual parts of these waveforms. In particular, the first embodiment can use spoken phrases or expressions as retrieval conditions even when the phrases or expressions include multiple accent nuclei.

### Second Embodiment

The second embodiment simplifies the calculations carried out when the number of features in a pitch pattern stored in the speech database 150 exceeds the number of features in the pitch pattern derived from speech input as a retrieval condition.

The second embodiment also has the configuration shown in FIG. 1, a description of which will be omitted.

When the number of local maxima, local minima, and inflection points in a pitch pattern stored in the speech database 150 exceeds the number of these features in a pitch pattern derived from speech input as a retrieval condition, since the speech input as a retrieval condition has a relatively featureless pitch pattern, a simplified comparison of its pitch pattern with the pitch pattern of the stored speech suffices. A way to simplify the comparison is to rederive the pitch pattern of the stored speech item so as to reduce the number of feature points.

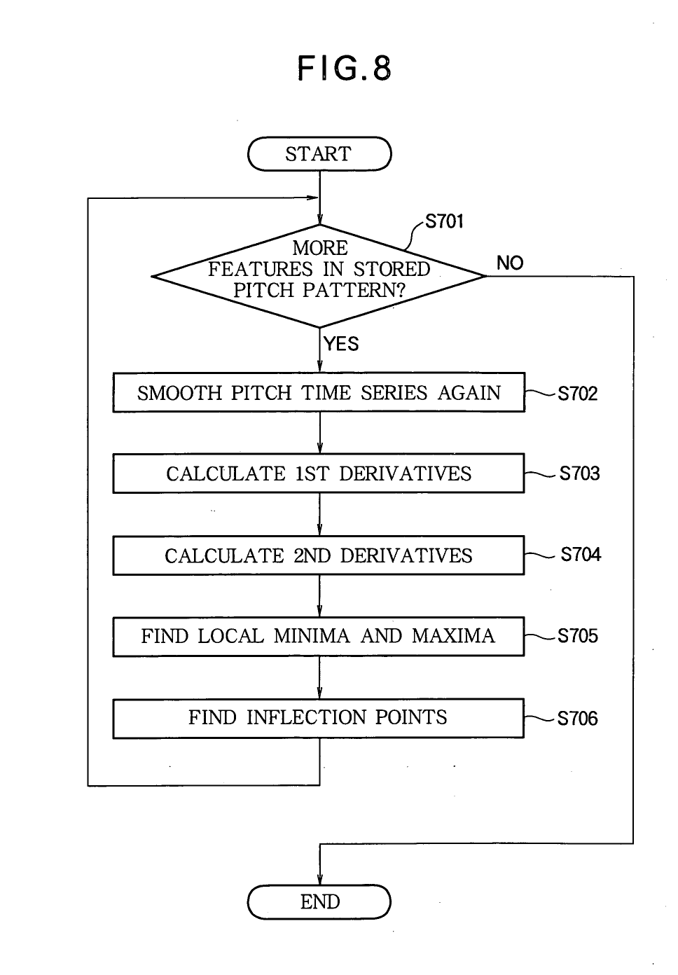

The procedure used in the second embodiment to rederive a stored pitch pattern is illustrated in FIG. 8. This procedure is carried out in step S506 in FIG. 6, before steps S601 to S603 in FIG. 7.

In step S701 in FIG. 8, the pattern extraction unit 130 compares the number of features in the pitch pattern of the speech input as a retrieval condition with the number of features in the stored pitch pattern which was fetched from the speech database 150 in step S502 in FIG. 6. The term ‘features’ in this flowchart refers to local maxima, local minima, and inflection points. If the number of features in the stored pitch pattern is equal to or less than the number of features in the pitch pattern of the speech input as a retrieval condition, the procedure ends.

If the number of features in the stored pitch pattern exceeds the number of features in the pitch pattern of the speech input as a retrieval condition, the pattern extraction unit 130 rederives the stored pitch pattern as follows.

In step S702, the pattern extraction unit 130 smoothes the pitch time series waveform of the stored speech item again by calculating moving averages with a longer window than before, for example, or using a low-pass filter with a lower cutoff frequency than before, to obtain a smoother time series pattern.

Steps S703 to S706 identical to steps S303 to S306 in FIG. 3 are now carried out on the resmoothed time series to find a new set of local maxima, local minima, and inflection points. The process then returns to step S701, and terminates if the number of these features is equal to or less than the number of features in the pitch time series of the speech input as a retrieval condition.

The pattern extraction unit 130 repeats steps S701 to S706 until the number of features in the resmoothed pitch pattern becomes equal to or less than the number of features in the pitch pattern of the speech input as a retrieval condition.

The pattern extraction unit 130 then performs steps S601 to S603 as described in the first embodiment to calculate the feature difference between the pitch pattern of the speech input and the resmoothed pitch pattern of the speech item stored in the speech database 150.

Resmoothing the pitch times series is one exemplary method of reducing the number of features in the pitch pattern, but any other method may be used instead. One alternative method is to increase the sampling period of the stored speech data.

As described above, in the second embodiment, before calculating feature differences between pitch patterns, if the stored pitch pattern has more features than the pitch pattern of the speech input as a retrieval condition, the pattern extraction unit 130 first reduces the number of features in the stored pattern. Essentially this means that if the speech input as a retrieval condition is spoken in a comparatively flat voice, the pattern extraction unit 130 smoothes the pitch time series of the stored speech until it is equally flat. This facilitates the comparison between the two time series and reduces the computational load.

In the embodiments described above, the pattern extraction unit 130 performs the speech retrieval process in FIG. 5 for all speech data stored in the speech database 150, but the retrieval time may be reduced by providing the database 150 with a suitable index so that only some of the stored patterns have to be examined.

Those skilled in the art will recognize that further variations are possible within the scope of the invention, which is defined in the appended claims.

What is claimed is:

1. A speech retrieval apparatus for retrieving a speech item stored in a speech database, comprising:
a speech input unit for receiving speech input as a retrieval condition;
a speech analysis unit for calculating values of a property of the speech input;
a pattern extraction unit for deriving a first temporal pattern of the values of the property calculated by the speech analysis unit, obtaining a second temporal pattern of values of said property in the speech item stored in the speech database, and calculating a difference between the first temporal pattern and the second temporal pattern; and
an output unit for outputting the speech item if the difference is less than a predetermined threshold value.

2. The speech retrieval apparatus of claim 1, wherein the second temporal pattern is stored in the speech database.

3. The speech retrieval apparatus of claim 1, wherein the property represents pitch.

4. The speech retrieval apparatus of claim 1, wherein the property represents power.

5. The speech retrieval apparatus of claim 1, wherein the pattern extraction unit derives the first temporal pattern by obtaining a first time series of the values of said property in the speech input and finding local minima, local maxima, and inflection points in the first time series.

6. The speech retrieval apparatus of claim 5, wherein the property represents pitch, and the pattern extraction unit smoothes the first time series before finding the local minima, local maxima, and inflection points in the first time series.

7. The speech retrieval apparatus of claim 5, wherein the local minima, the local maxima, and the inflection points have respective first time coordinates and first value coordinates, the first time coordinates and the first value coordinates constituting the first temporal pattern.

8. The speech retrieval apparatus of claim 7, wherein the second temporal pattern includes second time coordinates and second value coordinates of local minima, local maxima, and inflection points of a second time series of the values of said property in the speech item.

9. The speech retrieval apparatus of claim 8, wherein the pattern extraction unit calculates said difference as a sum of squares of differences between the first and second time coordinates and squares of differences between the first and second value coordinates.

10. The speech retrieval apparatus of claim 8, wherein the property represents pitch, and if there are more second time coordinates than first time coordinates, the pattern extraction unit smoothes the second time series until the number of second time coordinates is equal to or less than the number of first time coordinates.

11. The speech retrieval apparatus of claim 1, wherein the speech analysis unit also calculates a first phoneme sequence of the speech input, the pattern extraction unit compares the first phoneme sequence with a second phoneme sequence of the speech item, and the output unit outputs the speech item only if the second phoneme sequence matches the first phoneme sequence.

12. A method of retrieving a speech item from a speech database, comprising:
obtaining speech input as a retrieval condition;
calculating values of a property of the speech input;
deriving a first temporal pattern of the values of the property in the speech input;
obtaining a second temporal pattern of values of said property in the speech item;
calculating a difference between the first temporal pattern and the second temporal pattern; and
outputting the speech item if the difference is less than a predetermined threshold value.

13. The method of claim 12, wherein the property represents pitch.

14. The method of claim 12, wherein the property represents power.

15. The method of claim 12, wherein the first temporal pattern represents local maxima, local minima, and inflection points of the property.

16. A method of retrieving speech items from a speech database, comprising:
obtaining speech input as a retrieval condition;
analyzing the speech input to obtain a first phoneme sequence, a first pitch time series, and a first power time series of the speech input;
obtaining a first power pattern representing local minima, local maxima, and inflection points of the first power time series;
smoothing the first pitch time series;
obtaining a first pitch pattern representing local minima, local maxima, and inflection points of the smoothed first pitch time series;
analyzing a speech item stored in the speech database to obtain a second phoneme sequence, a second pitch time series, and a second power time series of the speech item;
obtaining a second power pattern representing local minima, local maxima, and inflection points of the second power time series;
smoothing the second pitch time series;
obtaining a second pitch pattern representing local minima, local maxima, and inflection points of the smoothed second pitch time series;
comparing the first phoneme sequence with the second phoneme sequence;
calculating a power feature difference between the first power pattern and the second power pattern;
calculating a pitch feature difference between the first pitch pattern and the second pitch pattern; and
outputting the speech item if the first phoneme sequence matches the second phoneme sequence, the power feature difference is less than a first threshold value, and the pitch feature difference is less than a second threshold value.

17. The method of claim 16, wherein the power feature difference is a sum of squares of differences between time coordinates of the local minima, local maxima, and inflection points of the first and second power time series and squares of differences between value coordinates of the local minima, local maxima, and inflection points of the first and second power time series, and the pitch feature difference is a sum of squares of differences between time coordinates of the local minima, local maxima, and inflection points of the first and second smoothed pitch time series and squares of differences between value coordinates of the local minima, local maxima, and inflection points of the first and second smoothed pitch time series.

18. The method of claim 16, further comprising smoothing the second pitch time series again, if the smoothed second pitch time series has more local minima, local maxima, and inflection points than the first smoothed pitch time series, until the smoothed second pitch time series has no more local minima, local maxima, and inflection points than the first smoothed pitch time series.
